(19) United States
(12) Patent Application Publication
(10) Pub. No.: US 2006/0017729 A1
(43) Pub. Date: Jan. 26, 2006

(54) Method to improve photorealistic 3D rendering of dynamic viewing angle by embedding shading results into the model surface representation

(75) Inventors: Alex Chunghen Chow, Austin, TX (US); Masahiro Yasue, Austin, TX (US)

Correspondence Address: Gregory W. Carr, 670 Founders Square, 900 Jackson Street, Dallas, TX, 75202, US

(73) Assignees: International Business Machines Corporation, Armonk, NY (US); Sony Computer Entertainment Inc., Tokyo (JP)

(21) Appl. No.: 10/897,350

(22) Filed: Jul. 22, 2004

(51) Int. Cl. G06T 15/50; G06T 15/60

(52) U.S. Cl. 345/426

(57) ABSTRACT

The present invention provides for rendering photorealistic 3D viewing angles. Lighting values are approximated across selected viewing angles. In fixed lighting situations, approximating across viewing angles allows rendering of a high order lighting detail with complex surfaces. A polynomial equation representing the surfaces will be solved for the coefficients to be used in the formula of the fixed viewing angle. If the number of light sources is too high only specular and diffusion surfaces can be efficiently calculated in the polynomial equation.

### BACKGROUND OF THE INVENTION

1. Field of the Invention

The present invention relates generally to three-dimensional (3D) rendering in a computer program and, more particularly, to a method to improve photorealistic 3D rendering fast enough for real-time application.

2. Description of the Related Art

The computation required to render photorealistic 3D images, such as raytracing and radiosity, is usually too high for interactive applications where view angles change constantly. Raytracing can be generally defined is a technique used in computer graphics to create realistic images by calculating the paths taken by rays of light entering the observer's eye at different angles. Raytracing mimics the way light travels to the eye. Therefore the computer has to figure out how each light interacts.

Radiosity is another technique for rendering a three dimensional (“3D”) scene that provides realistic lighting. Generally, the theory behind radiosity mapping is that you should be able to approximate the radiosity of an entire object by precalculating the radiosity for a single point in space, and then applying it to every other point on the object. This is because, among other things points in space that are close together all have approximately the same lighting. Radiosity programs are usually complementary to raytracing programs, with the radiosity calculations forming a pre-rendering section.

Many optimization methods have been used in the past to try to improve the real-time photorealistic rendering performance. Most methods optimize the update of model data structure in dealing with the dynamic aspect. Ray-caching or Render-caching approaches are similar but are limited to the previously viewed angle. In addition, the approximation is not utilized to speed up the calculation. One way to optimize raytracing is by fixing the lighting and fixing the viewing angle. In doing so, when a surface changes, you can cache the previously calculated result for a point in space. However, if the viewing angle does change, even if the rest of the data does not change, raytracing forces you to traverse each triangle again.

Another optimization method would be to precompute the result for a specific material so another calculation becomes unnecessary. A main concern with raytracing is to organize the algorithm, so that not all of the triangles have to be visited during calculation, particularly those not visible to the screen.

Another approach is similar to precomputation but different in the method of precomputation and the way to store the precomputed ideas. This approach is found in “Precomputed Radiance Transfer for Real-Time Rendering in Dynamic, Low-Frequency Lighting Environments” (Sloan, Kuatz, and Snyder) Proc. of SIGGRAPH '02, pp. 527-536, 2002. This approach exploits the characteristics of the low variant order of lighting environment. It precomputes the transfer scalar function and vector matrix which can significantly accelerate the final rendering stage. However, the radiance transfer function and vector matrix was a sampled space of the actual model surface. It approximates across the sample space. However, the idea in “Precomputed Radiance Transfer for Real-Time Rendering in Dynamic, Low-Frequency Lighting Environments” is not surface point based.

Creating a surface based sampling method would be able to approximate across the lighting values across viewing angles. Because of this, an invention with surface based sampling would be capable of dealing with high order lighting detail of a model with very complex surfaces.

Therefore, there is a need for a method to improve photorealistic 3D rendering of dynamic viewing angle by embedding shading results into the model surface representation that addresses at least some of the problems associated with conventional 3D rendering.

### SUMMARY OF THE INVENTION

The present invention provides for improving photorealistic three-dimensional rendering of dynamic viewing angles selects a viewing angle. A viewing angle corresponds to a number of subsurfaces. Shading results of the viewing angle for each subsurface are precalculated. A surface is formed using the shading results. This surface has nearby subsurfaces and the surface can be defined by a polynomial equation or formula. By placing a viewing angle into a formula representation of the subsurface, a projected viewing pixel value can be obtained.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 illustrates a line drawing depicting an exemplary scene at a first viewing angle;

FIG. 2 illustrates a line drawing depicting an exemplary scene at a second viewing angle;

FIG. 3 illustrates a computer system employable to render a plurality of viewing angles;

FIG. 4 illustrates pre-calculating shading results; and

FIG. 5 further illustrates forming a surface from the shading results.

### DETAILED DESCRIPTION OF THE INVENTION

The present invention is described to a large extent in this specification in terms of methods and systems for improving photorealistic three-dimensional rendering of dynamic viewing angles. However, persons skilled in the art will recognize that a system for operating in accordance with the disclosed methods also falls within the scope of the present invention. The system could be carried out by a computer program or parts of different computer programs.

This invention may also be embodied in a computer program product, such as a diskette or other recording medium, for use with any suitable data processing system. Persons skilled in the art would recognize that any computer system having suitable programming means will be capable of executing the steps of the method of the invention as embodied in a program product. Although most of the exemplary embodiments described in this specification are oriented to software installed and executing on computer hardware, persons skilled in the art would recognize alternative embodiments implemented as firmware or as hardware are within the scope of the present invention.

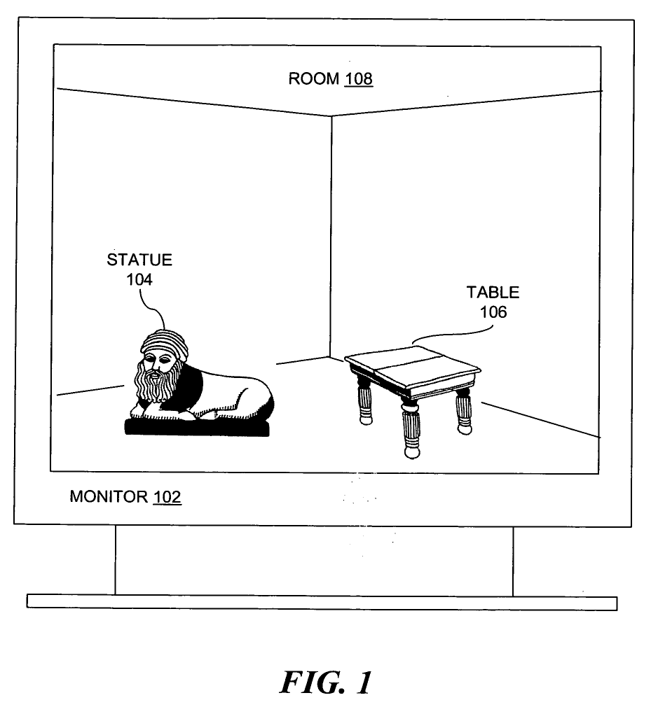

Turning now to FIG. 1, illustrated is a line drawing depicting an exemplary computer rendered scene viewed at a specific viewing angle. The example of FIG. 1 includes a monitor 102 displaying a scene including a room 108 containing a statue 104 and a table 106. FIG. 1 displays the statue 104 and the table 106 from a selected viewing angle. Both the statue and table are composed of surfaces which reflect or refract light.

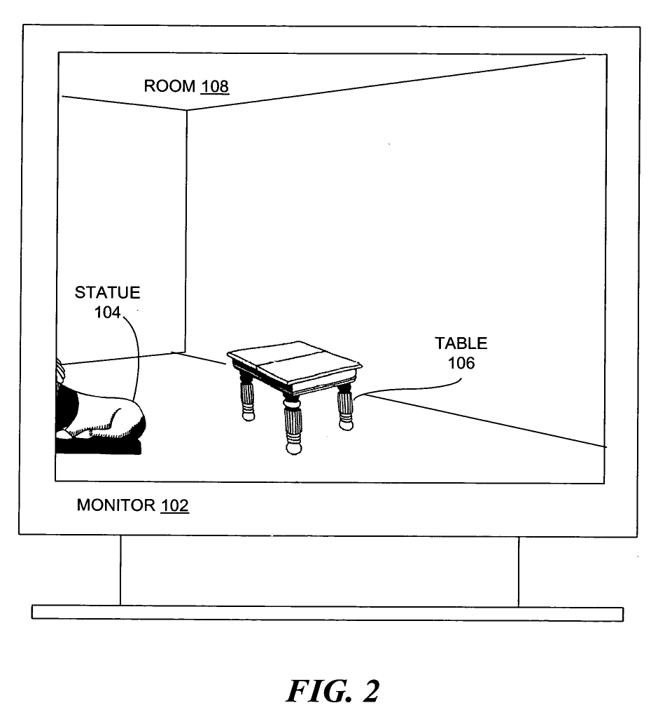

Turning now to FIG. 2, illustrated is a computer rendered scene viewed at a different selected viewing angle. The example of FIG. 2 includes the same monitor 102 displaying a scene including the same room 108 containing the same statue 104 and table 106. The difference between FIG. 2 and FIG. 1 is the viewing angle of the rendered scene. When the viewing angle changes the lighting reflected upon the surfaces in the scene changes, as well.

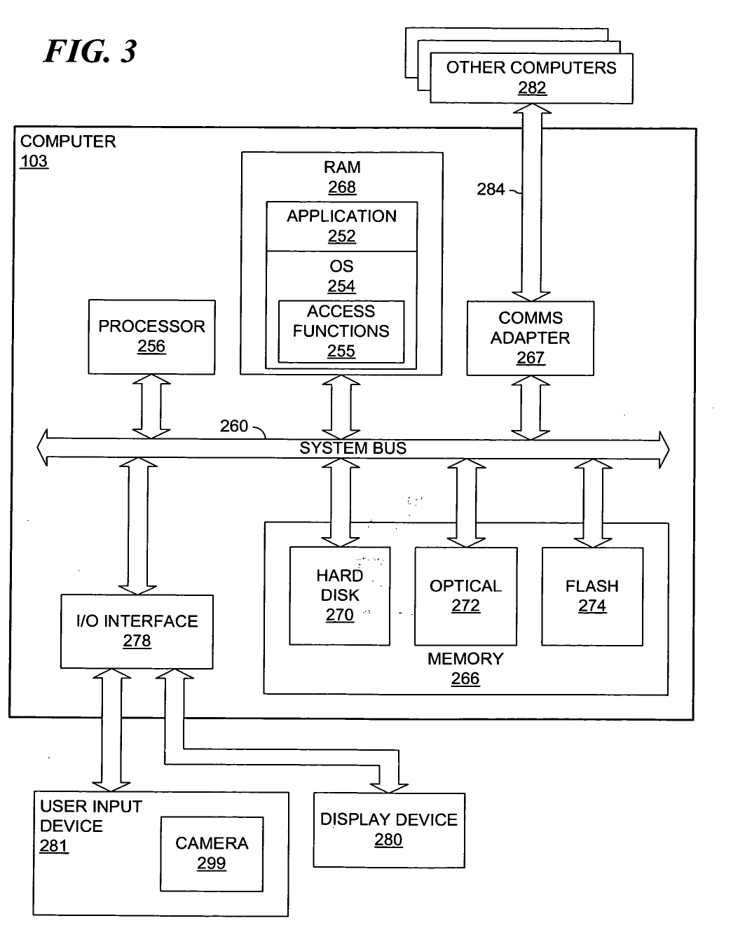

Turning now to FIG. 3, illustrated is a computer employable to render the various viewing angles of FIG. 1 and FIG. 2. The term “computer,” in this specification, refers to any automated computing machinery. The term “computer” therefore includes not only general purpose computers such as laptops, personal computer, minicomputers, and mainframes, but also devices such as personal digital assistants (PDA's), network enabled handheld devices, internet-enabled mobile telephones, and so on. For further explanation, FIG. 3 sets forth a block diagram of automated computing machinery comprising a computer 103 useful for viewing FIG. 1 and FIG. 2. The computer 103 of FIG. 3 includes at least one computer processor 256 or ‘CPU’ as well as random access memory 268 (“RAM”). Stored in RAM 268 is an application program 252. Application programs useful in accordance with various embodiments of the present invention include browsers, word, processors, spreadsheets, database management systems, email clients, TCP/IP clients, and so on, as will occur to those of skill in the art. When computer 103 is operated for rendering 3D scenes, application 252 includes 3D rendering software. Examples 3D rendering software include Alias' Maya, Softimage, Discreet's 3DSMax and so on.

Also stored in RAM 268 is an operating system 254. Operating systems useful in computers according to embodiments of the present invention include Unix, Linux™, Microsoft NT™, and others as will occur to those of skill in the art. Transport and network layer software clients such TCP/IP clients are typically provided as components of operating systems, including Microsoft Windows™, IBM's AIX™, Linux™, and so on. In the example of FIG. 3, operating system 254 also includes user input devices 281, and display devices 280. Examples of user input devices include digital cameras 299, webcams, mice, keyboards, numeric keypads, touch sensitive screens, microphones, and so on. One example of selecting a viewing angle of a scene to be rendered is by adjusting the viewing angle of a camera 299 recording a live scene. Examples of display devices include monitors, LCD displays, GUI screens, text screens, touch sensitive screens, Braille displays, and so on. Display devices such as monitors or LCD displays are capable of displaying a 3D rendered scene.

The example computer 103 of FIG. 3 includes computer memory 266 coupled through a system bus 260 to the processor 256 and to other components of the computer. Computer memory 266 may be implemented as a hard disk drive 270, optical disk drive 272, electrically erasable programmable read-only memory space (so-called ‘EEPROM’ or ‘Flash’ memory) 274, RAM drives (not shown), or as any other kind of computer memory as will occur to those of skill in the art. The example computer 103 of FIG. 3 includes communications adapter 267 that implements connections for data communications 284 to other computers 282. Communications adapters 267 implement the hardware level of data communications connections through which client computers and servers send data communications directly to one another and through networks. Examples of communications adapters 267 include modems for wired dial-up connections, Ethernet (IEEE 802.3) adapters for wired LAN connections, 802.11 adapters for wireless LAN connections, and Bluetooth adapters for wireless microLAN connections.

The example computer of FIG. 3 includes one or more input/output interface adapters 278. Input/output interface adapters 278 in computer 103 include hardware that implements user input/output to and from user input devices 281 and display devices 280. In the example of FIG. 3, applications 252 effect user-oriented input/output representing requests received through user input devices for access to computer resources controlled by operating system access functions 255 which may grant access to computer resources resulting in their return to requesters through display devices through one or more input/output interface adapters 278. In particular, an operating system function such as Unix's ‘chmod’ is an example of an access function 255 that controls access to a computer resource by affecting access permissions on files.

Application software 252 may be altered to implement embodiments of the present invention by use of plug-ins, kernel extensions, or modifications at the source code level in accordance with embodiments of the present invention. Alternatively, completely new applications or operating system software may be developed from scratch to implement embodiments of the present invention

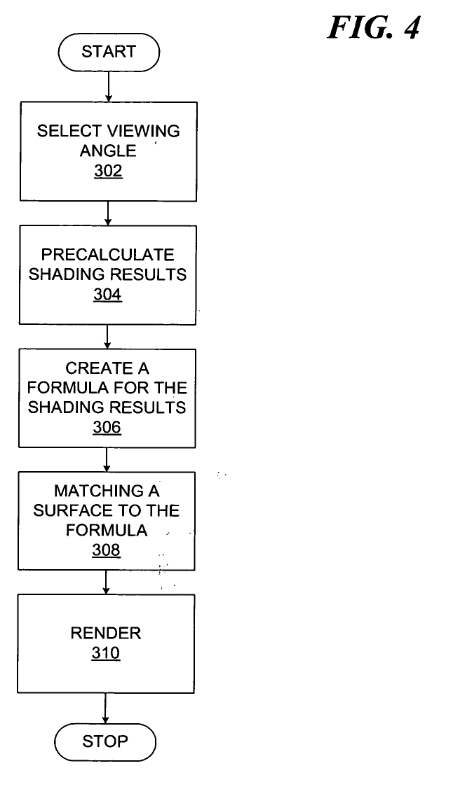

Turning now to FIG. 4, illustrated is a method for photorealistic three-dimensional rendering of dynamic viewing angles. Photorealistic rendering is capable of rendering diffusion surfaces, lighting, shadows, shading, and other characteristics of photorealism. In this specification “dynamic viewing angles” refers to viewing angles that can be continually changed and is not fixed.

The method of FIG. 4 begins by first selecting any viewing angle in a step 302. Selecting a viewing angle can be carried out by a computer program, a user accessing a computer thru a keyboard and a mouse or any others that would occur to those of skill in the art. The viewing angle is one of many parameters that are typically included in photorealistic three-dimensional rendering. Examples of a parameter include the number of light sources, the number of objects in a scene, any moving objects, and so on.

After selecting a viewing angle in step 302, the method of FIG. 4 also includes pre-calculating shading results in step 304. Pre-calculating shading results can be typically carried out by computing the shading results for each subsurface of the scene.

After the precalculating the shading results, the method of FIG. 4 includes creating a formula for the shading results in step 306. A formula for the shading results can be in the form of a polynomial equation. The formula also typically defines a surface with nearby surfaces that can be defined by another formula in the form of a polynomial equation.

After the creating a formula for the shading results in step 306, the method of FIG. 4 includes matching a surface to the formula in step 308 and rendering the surface and other surfaces in the scene in step 310.

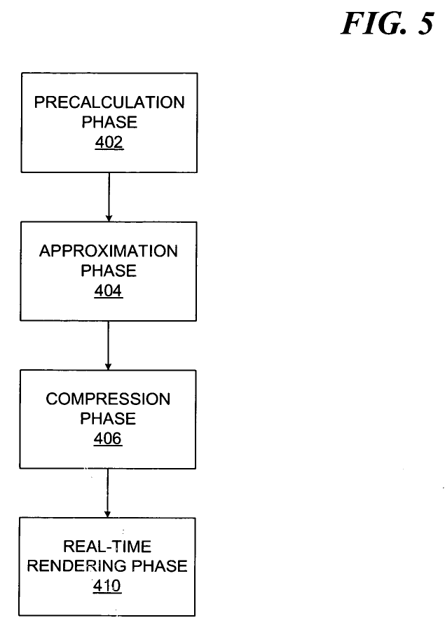

Turning now to FIG. 5, illustrated is a line drawing illustrating an exemplary method for photorealistic three-dimensional rendering of dynamic viewing angles in 4 phases. In the example of FIG. 5, the first phase is the precalculation phase 402. The pre-calculation phase 402 includes pre-calculating the shading results obtained from radiosity and raytracing. Radiosity of a scene can be typically carried out using the Monte Carlo method, the Stochastic Ray Method or any others that would occur to those of skill in the art.

Types of raytracing include, forward, backwards and distributed raytracing and any others that may occur to those of skill in the art. Forward raytracing simulates rays of light that emanate from a light source and determines where they end up by following a number of reflections on scene surfaces. Backwards raytracing operates by a scene casting rays into different directions until the rays strike a surface in the scene. At this point, the total amount of light at that surface is calculated by evaluating the distance to one or more light sources. A combination of both forward and backward raytracing named distributed raytracing or stochastic raytracing can be used to simulate scenes of extreme complexity. Various algorithms exist in the art for calculating each of these raytracing techniques and can be used to precalculate the raytracing shading results. Raytracing algorithms include recursive computer functions and functions incorporated into three-dimensional rendering software such as 3DSMAX, SoftImage, etc.

The next phase after the precalculation phase 402 is the approximation phase 404. In this phase, the precalculated shading results with the viewing angle as a variable is used to create a formula representing a surface. The approximation phase 404 also includes matching a surface to the formula representing a surface.

As an example, if the three dimensional scene to be rendered by the method of photorealistic three-dimensional rendering of dynamic viewing angles scene only had light as, a component, then the polynomial equation or formula could be represented by a one order polynomial equation or formula. If more elements were added such as reflective or specular elements, the order of the polynomial equation or formula would be increased as well to a 2^{nd} or 3^{rd} order polynomial equation or formula. The order of the polynomial equation that represents a surface also depends on the storage restriction.

Matching a surface to a formula includes calculating the coefficients of the polynomial equation or formula can be accomplished by solving for the coefficients of the polynomial equation. One exemplary method of calculating the coefficients of the polynomial equation or formula is by dropping from the polynomial equation or the formula the coefficients that can be considered insignificant due to their order. So in this exemplary method reality, only the dominating coefficient needs to be picked.

Following the approximation phase 404 is the compression phase 406. The surface matched to the formula representing a surface in the precalculation phase 404 has nearby subsurfaces defined by a formula or a polynomial equation. The polynomial equations or formulas of the nearby subsurfaces can be compressed when certain nearby subsurfaces can be reused in a scene. As an example, if a nearby surface has the same projected pixel values as another nearby surface, the formula that corresponds to the first nearby surface could be compressed to save storage space in the computer. Projected pixel values can be obtained by evaluating the polynomial equation or formula using a selected viewing angle. The viewing angles can be any viewing angle. Compressing means transforming data or in this example the data storing the formula to minimize the space required for storage or transmission. A limit needs to be set on the level of compression of the nearby surfaces.

Compressing the polynomial equations or formulas of the nearby surfaces typically requires selecting a decompression calculation to satisfy a real-time requirement. If the compression is too high or a high number of formulas for nearby surfaces have been compressed, the rate of decompression may be too slow to achieve the rendering results in real-time. Compressing formulas of nearby surfaces depends upon the storage size. As an example, the storage may only have 4 “words” to fit the polynomial equation or formula. In this example, an appropriate compression algorithm is used to compress the polynomial equation or formula into those 4 words. Typical compression algorithms useful for this process include the ‘zip’, ‘rar’ and any other algorithms that would occur to those of skill in the art.

“Words,” in programming, means the natural data size of a computer. The size of a word varies from one computer to another, depending on the central processing unit (CPU). For computers with a 16-bit CPU, a word is 16 bits (2 bytes). On large mainframes, a word can be as long as 64 bits (8 bytes) and so on.

Real-time refers to events simulated by a computer at the same speed that they would occur in real life. For example, a real-time program would display objects moving across the screen at the same speed that they would actually move. In graphics rendering, real-time typically requires frame rates of 15 frames per second or more.

The last phase in the example of FIG. 5 is the real-time rendering phase 410. In the rendering phase, pixels can be projected on the screen by calculating the pixel value. Rendering pixels can be carried out by using a triangle to eye ray-pixel intersection or by an eye to pixel-ray triangle intersection. These two intersection methods of rendering are not a limitation of the present invention. Other methods for rendering that occur to those of skill in the art can also be used with the present invention and is well within the scope of the invention.

As an example, under an eye to pixel ray-triangle intersection, the ray is tested by going from the eye through each pixel for an intersection with any object. There are many different methods to perform eye to pixel ray-triangle intersection. A recursive algorithm can be used to calculate the results of an eye to pixel ray-triangle intersection. In the exemplary embodiment using an eye to pixel ray triangle intersection, the value of a pixel in the figure can be calculated by simply applying the dynamic viewing angle into the formula associated with the corresponding triangle that results from the calculation by an eye to pixel ray/triangle intersection.

Unlike traditional raytracing methods which require multiple trips and analyzing reflection and refraction when a ray is shot out, an exemplary embodiment of the present invention enables the raytracing method with only one trip. In this exemplary embodiment, shooting out a ray once is enough because plugging the viewing angle into the equation with calculated coefficients for each point, the viewing angle along with the coefficients describes the color value of each visited point.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims

What is claimed is:

1. A method for photorealistic three-dimensional rendering of dynamic viewing angles, the method comprising:
precalculating shading results for a selected viewing angle;
creating a formula for the precalculated shading results;
matching a surface to the formula wherein a scene comprises a plurality of surfaces; and
rendering the scene by rendering the plurality of surfaces.

2. The method of claim 1 further comprising compressing the formulas of the nearby surfaces.

3. The method of claim 2 wherein compressing the formulas of the nearby surfaces further comprises selecting a decompression calculation to satisfy a real-time requirement.

4. The method of claim 1 wherein further comprising fixing all conditions except for a viewing angle.

5. The method of claim 1 wherein precalculating shading results of the selected viewing angle further comprises:
pre-calculating the radiosity and raytraced results for the selected view point; and
defining a two-dimensional surface using the value of the radiosity and raytraced results.

6. The method of claim 1 wherein matching a surface to the formula wherein a scene comprises a plurality of surfaces further comprises calculating the coefficients of a polynomial equation.

7. The method of claim 1 wherein obtaining a projected viewing pixel value by placing the viewing angle into a formula representing a subsurface further comprises using eye pixel ray-triangle intersection.

8. The method of claim 1 wherein obtaining a projected viewing pixel value by placing the viewing angle into a formula representing a subsurface further comprises using eye ray-pixel intersection.

9. A system for photorealistic three-dimensional rendering of dynamic viewing angles, the system comprising:
a means for precalculating shading results for a selected viewing angle;
a means for creating a formula for the precalculated shading results;
a means for matching a surface to the formula wherein a scene comprises a plurality of surfaces; and
a means for rendering the scene by rendering the plurality of surfaces.

10. The system of claim 1 further comprising a means for compressing the formulas of the nearby surfaces.

11. The system of claim 2 wherein a means for compressing the formulas of the nearby surfaces further comprises a means for selecting a decompression calculation to satisfy a real-time requirement.

12. A computer program product for photorealistic three-dimensional rendering of dynamic viewing angles, the computer program product having a medium with a computer program embodied thereon, the computer program comprising:
computer code for precalculating shading results for a selected viewing angle;
computer code for creating a formula for the precalculated shading results;
computer code for matching a surface to the formula wherein a scene comprises a plurality of surfaces; and
computer code for rendering the scene by rendering the plurality of surfaces.

13. A processor for photorealistic three-dimensional rendering of dynamic viewing, the processor including a computer program comprising:
computer code for precalculating shading results for a selected viewing angle;
computer code for creating a formula for the precalculated shading results;
computer code for matching a surface to the formula wherein a scene comprises a plurality of surfaces; and
computer code for rendering the scene by rendering the plurality of surfaces.
